(19) United States
(12) Patent Application Publication
(10) Pub. No.: US 2026/0338210 A1
(43) Pub. Date: Oct. 29, 2026

(54) METHOD FOR COMMISSIONING A PUMP WITH PUMP MOTOR, ARRANGED IN A HYDRAULIC SYSTEM

(71) Applicant: Schaeffler Technologies AG & Co. KG, Herzogenaurach (DE)

(72) Inventors: Erhard HODRUS, Achern (DE); Alexander RÖSCH, Achern (DE); Christian EBERLE, Bühl (DE)

(73) Assignee: Schaeffler Technologies AG & Co. KG, Herzogenaurach (DE)

(21) Appl. No.: 19/113,048

(22) PCT Filed: Aug. 14, 2023
(86) PCT No.: PCT/DE2023/100593

§ 371 Date: Mar. 19, 2025

(30) Foreign Application Priority Data
Sep. 30, 2022 (DE) 10 2022 125 281.7

(51) Int. Cl. F15B 19/00; F15B 15/18; F16D 25/06

(52) U.S. Cl. CPC F15B 19/00; F15B 15/18; F16D 25/06

(57) ABSTRACT

The invention relates to a method for detecting the correct rotational direction of a pump (100) of a hydraulic system of an actuator in a motor vehicle with a first switchable valve (300), which is actuated by means of energisation, and with the pump (100), which has a pump motor (1000) and which is activated by means of energisation, and with a control device, which controls the first switchable valve (300) and the pump (100), wherein in a first rotational direction, the pump (100) conveys fluid to a pressure line (700) and in a second direction conveys fluid to a reservoir (900), wherein the pressure line (700) has a pressure sensor (600) and is hydraulically connected to the first switchable valve (300), characterised in that for determining the rotational direction of the pump (100), the pump motor (1000) is energised sequentially in the two different rotational directions and in each case the pressure at the pressure sensor (600) is determined, and therefrom, the rotational direction of the pump (100) is deduced.

### CROSS-REFERENCE TO RELATED APPLICATIONS

This application is the U.S. National Phase of PCT Appln. No. PCT/DE2023/100593, filed Aug. 14, 2023, which claims priority to DE 102022125281.7, filed Sep. 30, 2022, the entire disclosures of which are incorporated by reference herein.

### TECHNICAL FIELD

The disclosure relates to a method of detecting the correct rotational direction of a pump of a hydraulic system of an actuator in a motor vehicle.

### BACKGROUND

In addition to the electric drive motors, numerous projects currently include hydraulics in the system. The hydraulics are used to cool the electric drive motors, to operate the clutches in a so-called decoupling unit and, if necessary, a parking lock, as described, for example, in the as yet unpublished German patent application DE 10 2022 113 487.3.

A pump motor drives a pump. The hydraulic oil conveyed by the pump is thus made available to a high-pressure system that is used to operate the actuators. In the high-pressure path, a pressure sensor is installed behind the pump and a valve with which the discharge can be controlled. During a commissioning routine, the pump is rotated and, according to the prior art, e.g., via a rotor position sensor of the motor, it is checked whether the correct rotational direction can be controlled.

From the prior art, hydraulic systems with an electrically driven reversing pump are known. In this regard, one rotational direction of the reversing pump can be assigned a volume flow function, such as a cooling function, and the other rotational direction of the reversing pump can be assigned an actuating function such as the actuation of a clutch and/or a parking lock. Such hydraulic systems and methods for their operation are known, for example, from the publications DE 10 2018 112 663 A1, DE 10 2018 112 665 A1, DE 10 2018 113 316 A1 and DE 10 2018 114 789 A1. Other hydraulic systems are known from the publications DE 10 2016 213 318 A1 and WO 2012/113 368 A1, among others.

However, to ensure the correct rotational direction of the pump, a rotor position sensor or a resolver is explicitly required.

### SUMMARY

The disclosure is based on the object that the pump in such a hydraulic system should be controlled without sensors for cost reasons. This means that the rotor position sensor is no longer required. In this case, it is no longer possible to check the rotational direction via the resolver.

The object is achieved by a method having one or more of the features disclosed herein.

The method according to the disclosure for detecting the correct rotational direction of a pump of a hydraulic system of an actuator in a motor vehicle with a first switchable valve, which is actuated by means of energization and with the pump, which has a pump motor and which is actuated by means of energization, and with a control device, which controls the first switchable valve and the pump, wherein in a first rotational direction the pump conveys fluid into a pressure line and in a second direction conveys fluid into a reservoir, wherein the pressure line has a pressure sensor and is hydraulically connected to the first switchable valve, provides that, for determining the rotational direction of the pump, the pump motor is energized sequentially in the two different rotational directions and in each case the pressure at the pressure sensor is determined, and therefrom, the rotational direction of the pump is deduced.

In a particularly preferred embodiment, it is provided that the correct rotational direction is present if the pressure determined at the pressure sensor is higher in the first rotational direction than in the second rotational direction.

In a further particularly preferred embodiment, it is provided that the hydraulic system of the actuator has a second switchable valve, which is also actuated by means of energization and the control device also controls the second switchable valve and wherein the pressure line is also hydraulically connected to the second switchable valve.

In a particularly preferred embodiment, the first switchable valve is a 2/2-way valve.

In a particularly preferred embodiment, the second switchable valve is a 4/2-way valve.

In a particularly preferred embodiment, it is provided that the first switchable valve is hydraulically connected to a cooling line for cooling a drive motor of the motor vehicle.

In a particularly preferred embodiment, it is provided that the second switchable valve is hydraulically connected to a clutch actuator for actuating a clutch.

In a particularly preferred embodiment, it is provided that the first switchable valve is closed when the pump is actuated in the first and second rotational directions.

In a particularly preferred embodiment, it is provided that, when the pump is actuated in the first and second rotational direction, the second switchable valve is switched in such a direction that a clutch piston moves into the clutch actuator in the direction of the nearest stop in the clutch cylinder.

In a particularly preferred embodiment, it is provided that, when the pump is actuated in the first and second rotational directions, the pump is actuated in such a way that a clutch piston is not moved into the clutch actuator.

The advantage of the method according to the disclosure is therefore that there is no need to reconnect the phase connections, since the commissioning routine according to the disclosure stores in a non-volatile memory of the control device which current leads to a desired forward rotation of the pump. In addition, there is no need to color-code the phase connection cables or to maintain the correct sequence of phase connections (polarity), since the commissioning routine can determine the correct energization for the lifetime of the control device.

### BRIEF DESCRIPTION OF THE DRAWINGS

Further advantages and advantageous configurations according to the present disclosure are the subject of the following figures and the description thereof.

In detail, in the figures:

FIG. 1 shows a hydraulic plan of a hydraulic system

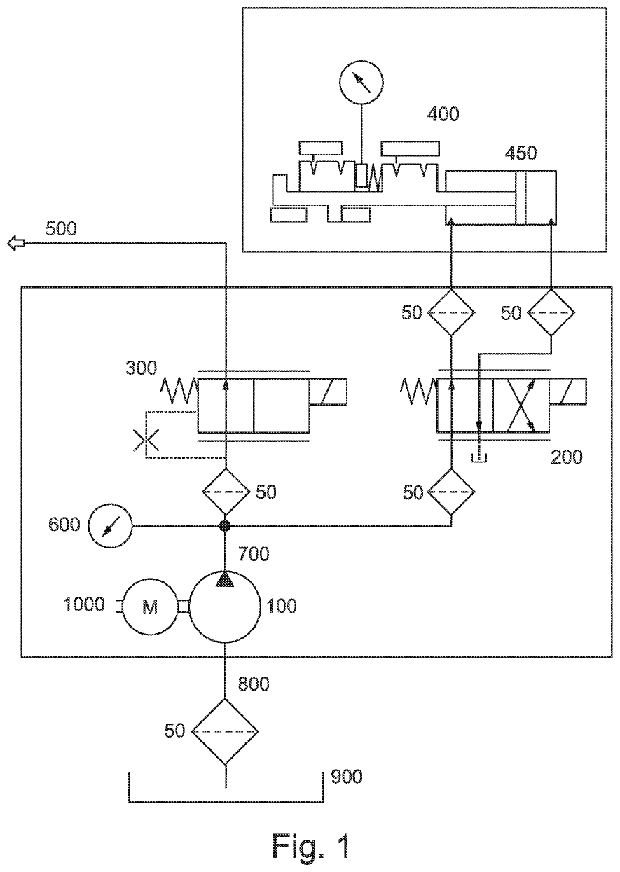

FIG. 2 shows a flowchart of the method according to the disclosure for commissioning a hydraulic pump in the hydraulic system of FIG. 1.

### DETAILED DESCRIPTION

During the commissioning according to the disclosure, the pressure measured by the pressure sensor 600 in the pressure line 700 of the high-pressure part of the hydraulic system is now to be taken into account, instead of the rotor position sensor, which no longer exists.

The system pressure control valve 300, a 2/2-way valve—hereinafter also referred to as the first switchable valve 300—in the high-pressure part of the hydraulic system must be controlled for the considerations in the commissioning routine according to the disclosure in such a way that an increased pressure can be established. This can be done by closing the system pressure control valve 300 in the method step 1100.

In addition, before or at the beginning of the actuation of the pump 100, the clutch actuator 400, more precisely the clutch piston 450, can be moved to one of the two stops in the cylinder of the clutch actuator 400 by means of the second switchable valve 200—a 4/2—way valve-so that once this state is reached, a pressure build-up can no longer be prevented or reduced by mechanically increasing the hydraulic volume. According to the disclosure, since the piston position within the cylinder is generally always known, the second switchable valve 200 is actuated accordingly to move to the closer stop, since it is not necessary to consider whether the clutch is thereby opened or closed during commissioning.

Alternatively, the actuation of the pump 100 can only take place less abruptly with limited strength, so that there is no significant movement of the clutch piston 450 within the clutch actuator 400 due to friction and a detent within the clutch actuator 400, so that the clutch piston 450 does not approach either of the two stops in the clutch cylinder. This still results in a sufficiently meaningful pressure build-up at the pressure sensor 600.

If the electric motor 1000 of the pump 100 rotates in the desired forward direction in the method step 1200, then the pressure in the pressure line 700 of the high-pressure part must increase significantly, since the system pressure control valve 300 is controlled at a correspondingly high level. Here, for example, a pressure of around 8 bar is expected. The measured pressure of the pressure sensor 600 can be easily evaluated.

If the electric motor 1000 rotates in the wrong direction, the pressure increase will not occur and the pressure in the pressure line 700, the actual high-pressure side, will even be reduced, since the high-pressure side becomes the suction side if the rotational direction is incorrect.

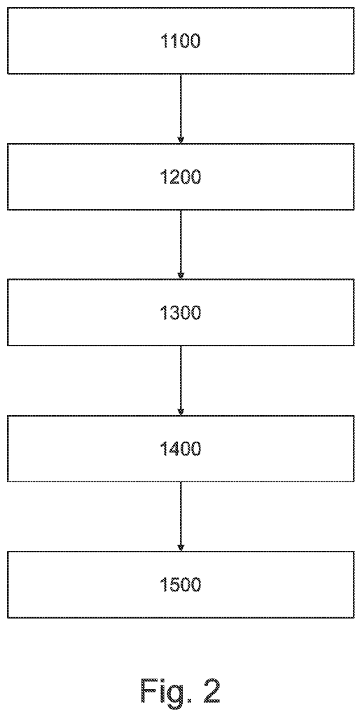

In this case, the commissioning routine must store a suitable value in the non-volatile memory of the control device for later use. During subsequent use, the stored corrected value must be used; the motor will then always turn in the correct direction. The test procedure is shown in FIG. 2.

For plausibility purposes, in particular after the intended current supply in the method step 1200 has led to a desired forward rotation, the current supply is then reversed in the method step 1300 and it is checked whether the pressure sensor 600 indicates a sufficient drop in pressure in this rotational direction.

The commissioning procedure can easily be repeated later, e.g., in a workshop.

A repetition is also conceivable during operation of the vehicle, for example, if a loss of the non-volatile memory is displayed. By performing the routine, the system can be brought into a drivable state, enabling a limp home. The system can inform the driver of unusual waiting times via the message display.

There are further advantages for production. Since the order of the phase connections no longer plays a role due to the mandatory test during commissioning, color coding of the phase connection cables is not necessary. Rejection due to reversed colors is therefore impossible.

If necessary, the standard marking with one color also clarifies possible misallocations during pinning, in particular when working with suppliers. In addition, cost advantages are likely to arise from the higher order quantities in one color.

Variants are also conceivable, such as a one-sided test for high pressure in the method step 1200, without then carrying out the method step 1300 in order to shorten the process. Another possibility is a plausibility check with a rotor position sensor, if one is present in the system.

### LIST OF REFERENCE SYMBOLS

50 Filter
100 Pump
200 Second switchable valve (clutch)
300 First switchable valve (cooling)
400 Clutch actuator
450 Clutch piston
500 Cooling line
600 Pressure sensor
700 Pressure line
800 Intake line
900 Reservoir
1000 Pump motor
1100 Method step
1200 Method step
1300 Method step
1400 Method step
1500 Method step

1. A method for detecting a correct rotational direction of a pump of a hydraulic system of an actuator in a motor vehicle with a first switchable valve, which is actuated by means of energization and with the pump, which has a pump motor and which is actuated by means of energization, and with a control device, which controls the first switchable valve and the pump, the method comprising:
rotating the pump in a first rotational direction and conveying fluid into a pressure line;
rotating the pump in a second direction and conveying fluid into a reservoir;
wherein the pressure line has a pressure sensor and is hydraulically connected to the first switchable valve; and
for determining the rotational direction of the pump, sequentially energizing the pump motor in the first and second rotational directions and in each case determining the pressure at the pressure sensor, and deducing the rotational direction of the pump therefrom.

2. The method according to claim 1, wherein the correct rotational direction is present if the pressure determined at the pressure sensor is higher in the first rotational direction than in the second rotational direction.

3. The method according to claim 1, wherein the hydraulic system of the actuator has a second switchable valve, which is also actuated by energization and the control device also controls the second switchable valve, and wherein the pressure line is also hydraulically connected to the second switchable valve.

4. The method according to claim 1, wherein the first switchable valve is a 2/2-way valve.

5. The method according to claim 3, wherein the second switchable valve is a 4/2-way valve.

6. The method according to claim 1, wherein the first switchable valve is hydraulically connected to a cooling line for cooling a drive motor of the motor vehicle.

7. The method according to claim 3, wherein any one of claims 3 to the second switchable valve is hydraulically connected to a clutch actuator for actuating a clutch.

8. The method according to claim 1, further comprising closing any one the first switchable valve closed when the pump is actuated in the first and second rotational directions.

9. The method according to claim 7, further comprising actuating the second switchable valve actuated in the first and second rotational directions when the pump is actuated, and moving a clutch piston into a clutch actuator in a direction of a nearest stop in a clutch cylinder.

10. The method according to claim 9, wherein when the pump is actuated in the first and second rotational directions, the pump is actuated such that the clutch piston does not move into the clutch actuator.

11. A method for detecting a correct rotational direction of a pump of a hydraulic system of an actuator in a motor vehicle with a first switchable valve, which is actuated by energization and with the pump, which has a pump motor and which is actuated by energization, and with a control device, which controls the first switchable valve and the pump, the method comprising:
rotating the pump in a first rotational direction and conveying fluid into a pressure line which has a pressure sensor and is hydraulically connected to the first switchable valve;
rotating the pump in a second direction and conveying fluid into a reservoir;
for determining the rotational direction of the pump, closing the first switchable valve, sequentially energizing the pump motor in the first and second rotational directions and in each case determining the pressure at the pressure sensor, and determining the correct rotational direction of the pump being in the first direction by the pressure determined at the pressure sensor being higher in the first rotational direction than in the second rotational direction.

12. The method according to claim 11, wherein the hydraulic system of the actuator has a second switchable valve, which is also actuated by energization and the control device also controls the second switchable valve, and the pressure line is also hydraulically connected to the second switchable valve.

13. The method according to claim 12, wherein the first switchable valve is a 2/2-way valve.

14. The method according to claim 13, wherein the second switchable valve is a 4/2-way valve.

15. The method according to claim 14, wherein the first switchable valve is hydraulically connected to a cooling line for cooling a drive motor of the motor vehicle.

16. The method according to claim 15, wherein the second switchable valve is hydraulically connected to a clutch actuator for actuating a clutch.

17. The method according to claim 13, further comprising actuating the second switchable valve in the first and second rotational directions when the pump is actuated, and moving a clutch piston into a clutch actuator in a direction of a nearest stop in a clutch cylinder.

18. The method according to claim 17, wherein, when the pump is actuated in the first and second rotational directions, the pump is actuated such that the clutch piston does not move into the clutch actuator.
